(19) United States
(12) Patent Application Publication
(10) Pub. No.: US 2011/0193332 A1
(43) Pub. Date: Aug. 11, 2011

(54) UNIT SUPPORT FOR THE BODY OF A MOTOR VEHICLE, BULKHEAD MODULE WITH UNIT SUPPORT, COCKPIT MODULE FOR A VEHICLE BODY, BODY STRUCTURE, AND FINALLY ASSEMBLED BODY

(75) Inventors: Udo MILDNER, Limburg (DE); Uwe SALLE, Undenheim (DE)

(73) Assignee: GM GLOBAL TECHNOLOGY OPERATIONS LLC, Detroit, MI (US)

(21) Appl. No.: 13/023,180

(22) Filed: Feb. 8, 2011

(30) Foreign Application Priority Data
Feb. 9, 2010 (DE) 102010007228.1

(51) Int. Cl. B62D 21/00

(52) U.S. Cl. 280/781

(57) ABSTRACT

A unit support is provided for the body of a motor vehicle having at least one connection point for the connection of a component of the engine compartment of the motor vehicle. It is provided that the unit support is substantially formed by the bulkhead of the motor vehicle, which separates the engine compartment from the passenger compartment, and can be installed together with the at least one component as a preassembled structural unit into the body and can be connected to the instrument board of the motor vehicle. The invention further relates to a preassembled bulkhead module with such a unit support, a cockpit module for connection to the bulkhead module, and a body structure for receiving a bulkhead module.

### CROSS-REFERENCE TO RELATED APPLICATION

This application claims priority to German Patent Application No. 102010007228.1, filed Feb. 9, 2010, which is incorporated herein by reference in its entirety.

### TECHNICAL FIELD

The technical field relates to a unit support for the body of a motor vehicle having at least one connection point for the connection of a component of the engine compartment of the motor vehicle. The technical field further relates to a preassembled bulkhead module and a cockpit module for a motor vehicle body. The technical field furthermore relates to a body structure and a finally assembled body for a motor vehicle.

### BACKGROUND

During the manufacture of motor vehicles, usually individual subcomponents are preassembled to form structural units, which are then installed in the motor vehicle in the course of the final assembly. Improvements and facilitations during assembly are thereby achieved. The preassembled structural units usually comprise a unit support, on which the components or units of the motor vehicle can be preassembled. The unit support consequently forms the base frame of the preassembled structural unit.

It is known from DE 10 2004 011 523 A1 that such a unit support forms an assembly unit, which receives components of the engine compartment of the motor vehicle. The unit support is used there to be mounted onto the bulkhead of the motor vehicle, which separates the engine compartment from the passenger compartment.

A unit support for the body of a motor vehicle is further known from DE 33 15 646 A1. The unit support there is part of an assembly unit, which not only accommodate components of the engine compartment but also comprises the entire bulkhead together with the instrument board. As a result of the multiplicity of preassembled components, the preassembled structural unit therefore has a relatively large volume, so that the installation of the assembly unit in the body of the motor vehicle can only be carried out if no hood is mounted on the motor vehicle. Since, however, at the time of assembly of the bulkhead, the hood has already been mounted; hitherto the hood is dismounted again to install the assembly unit and then mounted again after installing the assembly unit. This procedure is associated, on the one hand, with an appreciable assembly effort and on the other hand, has the risk that the paintwork of the hood will be damaged, which results in subsequent repair work. In order to be able to mount the hood with the requisite precision during its reassembly, a corresponding assembly jig must additionally be available.

Against this background, it is at least on object to provide a unit support for the body of a motor vehicle having the features specified initially, which facilitates the final assembly of a motor vehicle and simplifies this compared with the final assembly hitherto. Furthermore, a preassembled bulkhead module having such a unit support is to be proposed, by which means dismounting the hood for installation of the bulkhead module is not necessary in contrast to the case hitherto. In addition, a body structure for such a bulkhead module is to be proposed as well as a corresponding finally assembled body. In addition, other objects, desirable features and characteristics will become apparent from the subsequent detailed description, and the appended claims, taken in conjunction with the accompanying drawings and this background.

### SUMMARY

The unit support is suitable for installation in the body of a motor vehicle. The unit support has at least one connection point for connection of a component for the engine compartment of the motor vehicle. The unit support is substantially formed by the bulkhead of the motor vehicle, which separates the engine compartment from the passenger compartment, and can be installed together with the at least one component as a preassembled structural unit into the body and can be connected to the instrument board of the motor vehicle.

As a result of this measure, a preassembled structural unit can be formed, which receives a plurality of components of the motor vehicle, in particular components of the engine compartment and consequently facilitates the final assembly of the motor vehicle to a considerable degree. Furthermore, compared with the unit supports used hitherto, an appreciable simplification is obtained during assembly since the preassembled structural unit can be installed separately from the instrument board. As a result of the installation of the unit support as a preassembled structural unit without the instrument board, a relatively compact structural unit is obtained, during the mounting of which into the motor vehicle, the hood need not be dismounted. The hood merely needs to be fixed in a defined open position.

The unit support can also be implemented without additional expenditure of material since it is formed by the bulkhead itself. The unit support can be implemented to be particularly light in terms of weight since additional components are not necessary for this. The unit support is particularly suited for being installed between the side walls of the motor vehicle body.

It is possible that the bulkhead is formed from one or at least two deep-drawn and/or extruded sheets. By this means the bulkhead and connection point or connection points can be implemented simply and inexpensively in the desired form. In order to be able to make the unit support or the bulkhead particularly light in terms of weight, it is further possible that the bulkhead comprises at least one light metal sheet, in particular is formed from one or at least two light metal sheets.

If the unit support or the bulkhead is formed from at least two sheets, the sheets should preferably be joined to one another by means of rivet, clinch, and/or welded joints. By this means, the sheets can be joined with little expenditure and in a simple manner in the course of an automated production process, in particular the final assembly of the motor vehicle.

According to one embodiment, it is provided that the unit support has at least one surface section, by means of which the unit support can be connected to a body structure and/or the instrument board of the motor vehicle. By this means, a defined surface is achieved on the unit support by which means the unit support can be brought to abut against a corresponding surface of the motor vehicle structure and/or the instrument board. As a result of the abutment at the mutually corresponding surfaces, a defined connection point is thereby achieved, at which, for example, an additional fixing for the positive, nonpositive and/or seamless joining of the unit support to the body structure and/or the instrument board can then take place in a simple manner.

The unit support can preferably be fixed by means of its surface section on the body structure and/or on or to the instrument board by forming at least one adhesive connection and/or at least one screw connection. For this purpose, at least one through opening for screws can be provided, for example, on the surface section. Naturally, such an at least one through opening can also be implemented outside the surface section. The unit support is consequently suitable for being fixed on at least one side wall of the body so that a firm connection between the two side walls of the body can be produced by means of the unit support, the unit support itself in turn forming the bulkhead separating the engine compartment from the passenger compartment.

According to one embodiment, on the engine compartment side, a plurality of connection points are provided, which serve for connection of a wiper system, a strut brace, a brake servo unit possibly with a supply tank for brake fluid, heat, and/or sound-insulating material, a support for the windshield and/or at least one drain element for the fluid drain from the fluid container of the bulkhead. The unit support is thereby configured to carry the essential and most units of the engine compartment. A preassembled structural unit can consequently be formed by means of the unit support which appreciably simplifies and facilitates the final assembly of the motor vehicle in the area of the engine compartment since merely the unit support with the units or components mounted thereon needs to be installed for this purpose.

The fluid container is understood to be the bulkhead area in front of the windshield. The water draining via the windshield is collected in this fluid container and removed. The fluid container can also be designated as water container and the fluid drain as water drain.

According to a further embodiment, on the passenger compartment side, connection points are provided, which serve for connection of heat- and/or sound-insulating material and/or the pedals of the motor vehicle. The unit support thus allows the preassembly of a structural unit, which also constitutes facilitation for the final assembly of the motor vehicle in regard to components of the interior or passenger compartment of the motor vehicle. This is because these components of the interior do not need to be mounted individually.

A preassembled bulkhead module is provided for a vehicle body which has a unit support of the type described previously. The unit support forms the basic structure of the bulkhead module, which can be preassembled separately from the main production line in a separate assembly station. A preassembly at a completely different location is naturally also possible so that, for example, the bulkhead module can be supplied already preassembled by a subcontractor for final assembly in the main production line.

It is possible that the bulkhead module comprises a wiper system, a brake servo unit possibly with a supply tank for brake fluid, heat and/or sound-insulating material, a support for the windshield, a fluid container, and/or at least one drain element for the fluid drain from the fluid container, in particular mounted on the unit support. These components of the engine compartment are preferably mounted on the unit support. The bulkhead module consequently comprises the most and essential components or units of the engine compartment and allows these components or units of the body to be integrated in a simple and easy manner through the mere installation of the bulkhead module.

According to a further embodiment, it is provided that the bulkhead module comprises at least one strut brace. A strut brace is understood to be a structural component, which interconnects the two front body-side suspension strut mounts of the motor vehicle and thereby increases the torsional stiffness of the motor vehicle body so that an improved endurance behavior of the motor vehicle body is thereby achieved.

According to a further embodiment, it is provided that the strut brace is preassembled on the fluid container of the bulkhead module. For this purpose, the strut brace is preferably preassembled on a flange of the water container of the bulkhead running transversely to the direction of travel. The preassembly is preferably accomplished by means of at least one screw connection.

In this case, it is possible that a sealing element is interposed between the strut brace and the flange of the fluid container. By this means, the fluid container is sealed against ingress of exhaust and/or fluid from the engine compartment. Since the strut brace is present preassembled on the bulkhead wall, the sealing element is already compressed between the strut brace and the flange of the fluid container mounted thereon and thus performs a sealing function.

A further embodiment relates to a cockpit module for a vehicle body. The cockpit module is a preassembled structural unit, which is configured for mounting on a bulkhead module of the type described previously. A cockpit is to be understood as the so-called instrument board, which is also designated as instrument panel. Since the cockpit area is implemented by means of the cockpit module as a preassembled structural unit, a facilitation and simplification is achieved to an appreciable extent during the final assembly of the vehicle body in the cockpit area since the installation of individual components in the cockpit area can be largely or entirely avoided in the course of the final assembly.

As a result of the cockpit module, a compact structural unit is achieved which can be assembled after installing the bulkhead module in the motor vehicle. This appreciably facilitates the final assembly of the motor vehicle, especially as the hood need not be dismounted for installation of the cockpit module.

According to one embodiment, it is provided that the cockpit module comprises a heating and/or air-conditioning system, a steering column possibly with steering wheel, a radio, at least one airbag, control equipment, cable sets, and/or the like components of the passenger compartment.

A further embodiment relates to a body structure for a motor vehicle. The body structure is configured for receiving a bulkhead module of the type described previously and/or a cockpit module of the type described previously. It is possible that the body structure has at least one adhesive channel, adhesive passage, or at least one surface section, which together with an appurtenant surface section of the bulkhead module and/or the cockpit module forms a channel or the like passage for adhesive to pass through for a connection of the bulkhead module and/or cockpit module to the body structure. By this means, the bulkhead module can be fastened on the body structure in a particularly simple and flexible manner. The same applies to the fastening of the cockpit module on the body structure or the bulkhead module. As a result of the formation of a channel for the adhesive, the possibility is obtained that cockpit module and/or bulkhead module are initially aligned with respect to the vehicle body and then the adhesive is guided from a pouring-in region into the corresponding adhesive areas through the channel formed in this way. An adhesive bonding is thereby possible in a simple manner, the adhesive bond being formed in a largely running manner.

According to a further embodiment, it is provided that the body structure has a bulkhead cross member, in particular a lower bulkhead cross member, which can be connected to the bulkhead module. The bulkhead cross member should be understood as a support profile, which extends in the direction of the bulkhead, in particular substantially transversely to the direction of travel. A stiffening of the body structure is achieved by the bulkhead cross member, in particular when the bulkhead cross member in conjunction with the front floor structure forms an adhesive channel for connection to the bulkhead module.

Again a further embodiment relates to a finally assembled body for a motor vehicle. The body comprises at least one body structure of the type described previously, a bulkhead module of the type described previously, and possibly a cockpit module of the type described previously.

The bulkhead module and the body structure are preferably interconnected at least by means of at least one connection point of the bulkhead module, which serve for connection of one component of the engine compartment or passenger compartment. The connection point can, for example, be configured for connection of the wiper system to the bulkhead module. The connection points therefore have a multiple function, whereby the degree of integration of the entire body is increased and as a result of components being saved, the body can thereby be lighter in weight. As a result of the fewer components to be built in, easier assembly is also achieved.

Further aims, advantages, features, and possible applications of the present invention are obtained from the following description of a plurality of exemplary embodiments by reference to the drawings. In this case, all the features described and/or depicted form the subject matter by themselves or in any meaningful combination, regardless of their summarization in the claims or their back relationship.

### BRIEF DESCRIPTION OF THE DRAWINGS

The present invention will hereinafter be described in conjunction with the following drawing figures, wherein like numerals denote like elements, and

FIG. 1 shows a possible embodiment of a unit support according to an embodiment in perspective view;

FIG. 2 shows a possible embodiment of a bulkhead module with a unit support according to the embodiment in perspective view from the front;

FIG. 3 shows the bulkhead module according to FIG. 2 in perspective view from the rear;

FIG. 4 shows a possible embodiment of a body structure according to an embodiment in plan view;

FIG. 5 shows the body structure according to FIG. 4 in perspective view as a section of the left side;

FIG. 6 shows the body structure according to FIG. 4 in front view;

FIG. 7 shows a section from the engine compartment area of the body of a motor vehicle with a bulkhead module in a first position during its final assembly in a view from above; and

FIG. 8 shows various positions of the bulkhead module during its installation in the vehicle body, shown in cross-sectional views.

### DETAILED DESCRIPTION

The following detailed description is merely exemplary in nature and is not intended to limit application and uses. Furthermore, there is no intention to be bound by any theory presented in the preceding background or summary or the following detailed description.

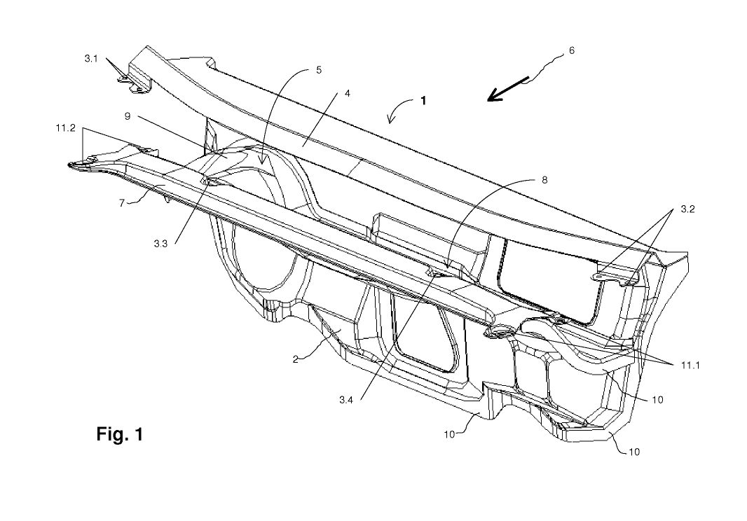

FIG. 1 shows, in schematic view, one possible embodiment of a unit support 1 for the body (not shown) of a motor vehicle. The unit support 1 is substantially formed by the bulkhead 2 of the motor vehicle which separates the engine compartment from the passenger compartment. For this purpose, the unit support 1 is preferably formed by at least two deep-drawn and/or extruded sheets, in particular light metal sheets, which are interconnected by means of rivet, clinch, and/or welded joints.

The unit support 1 has at least one, preferably two connection points 3.1, 3.2 for the wiper system (not shown) of the motor vehicle. Furthermore, a windshield support 4 is formed on the unit support 1, on which the windshield (not shown) of the motor vehicle is supported or received. The connection points 3.1 and 3.2 for the wiper system are preferably disposed on the windshield support 4. The connection points 3.1 and 3.2 are preferably disposed on the two opposite end sections of the elongate windshield support 4 and protrude from the bulkhead 2 and the windshield support 4 when viewed in the direction of travel 6 of the motor vehicle.

The unit support 1 further comprises a strut brace 7 to improve the torsional stiffness of the body in the area of its bulkhead 2 separating the engine compartment from the passenger compartment. The strut brace 7 is preferably mounted on a flange 8 disposed transversely to the direction of travel 6, which is associated with a fluid container 5. In the design of the unit support 1 according to FIG. 1, the flange 8 is disposed on, in particular is molded on, a partition plate 9, which preferably extends transversely to the direction of travel substantially over the length of the bulkhead 2. At least one, preferably two connection points 3.3, 3.4 are provided for fastening the strut brace 7.

The strut brace 7 has at least one connection point 11.1 and 11.2 at each of its two longitudinal-side ends, by which means the strut brace 7 can preferably be fastened on front body-side suspension strut mounts (not shown) of the motor vehicle, preferably by means of screw connections.

The unit support 1 has a surface section 10, by which mean of the motor vehicle. The surface section 10 is preferably disposed in the edge area of the bulkhead 2 and preferably extends substantially circumferentially over the side sections of the unit support and its lower longitudinal side and preferably terminates against the windshield support 4 disposed on the upper longitudinal side of the bulkhead 2. The surface section 10 is particularly suited for adhering the unit support 1 to the body (not shown) of the motor vehicle.

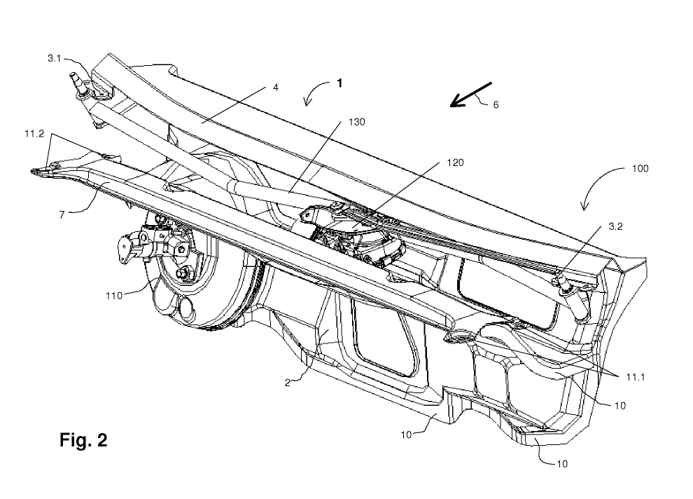

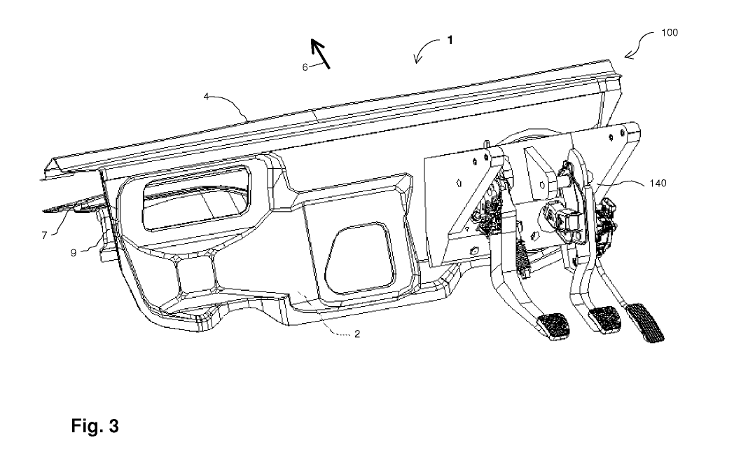

FIG. 2 and FIG. 3 show a possible embodiment of a bulkhead module 100, viewed in one case from the passenger compartment side (FIG. 3) and viewed in the other case from the engine compartment side (FIG. 2). The bulkhead module 100 has as its main component the unit support 1 according to FIG. 1.

Components of the bulkhead module 100 according to FIG. 2 and FIG. 3, which are identical to or have the same function as components of the unit support 1 according to FIG. 1, are provided with the same reference numbers; in this respect, reference is made to the description to FIG. 1.

FIG. 2 and FIG. 3 show the bulkhead module 100 as a preassembled structural unit, on the unit support 1 whereof various units or components of the engine compartment as well as units or components of the passenger compartment are already mounted. As is apparent from FIG. 2, for example, a brake servo unit 110 and a wiper system 120 are already preassembled on the unit support 1 of the bulkhead module 100. The linkage 130 pertaining to the wiper system 120 is preferably already also mounted on the unit support 1, the drive elements driving the windshield wiper also being already preassembled at the fastening points 3.1 and 3.2. Furthermore, the storage tank (not shown) for the brake fluid as well as heat-insulating material mats and/or sound-insulating material mats or mats made of a combination of sound-insulating material are already preassembled on the unit support 1. The unit support 1 already comprises, as stated with reference to FIG. 1, the windshield support 4 and the strut brace 7.

As is apparent from FIG. 3, the pedals 140 of the motor vehicle are already preassembled on the bulkhead module 100 on the side facing the passenger compartment (not shown). Furthermore, heat and/or sound insulation by means of appropriate material can be attached to the unit support 1 on the side facing the passenger compartment.

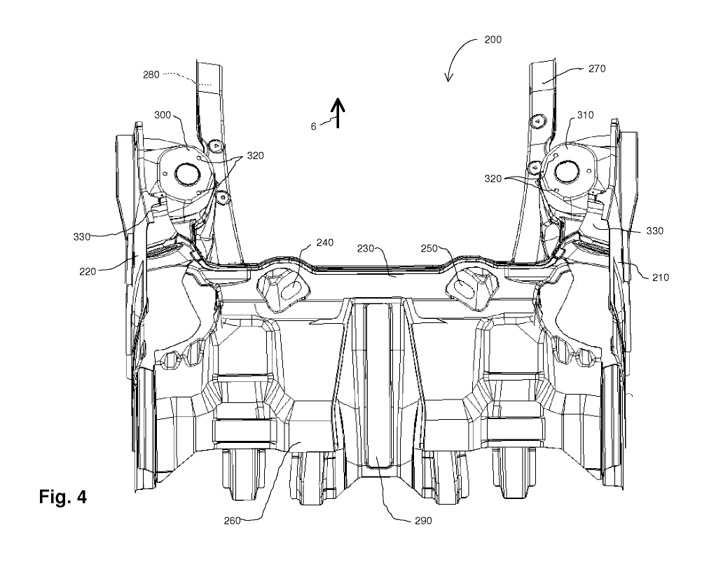

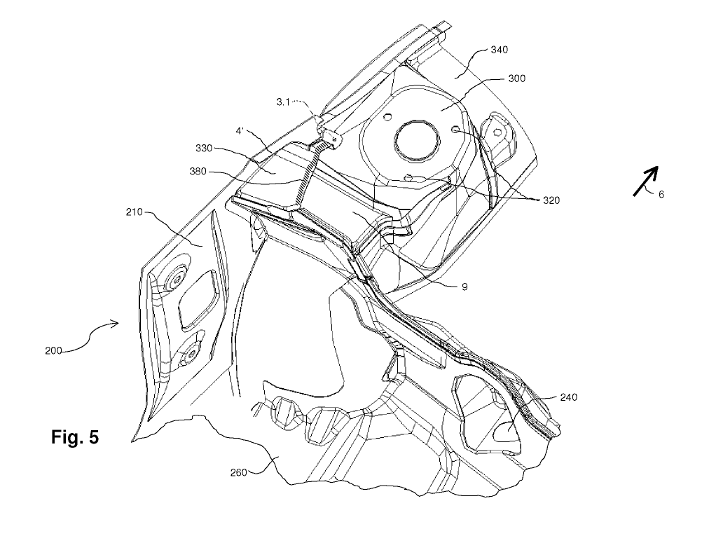

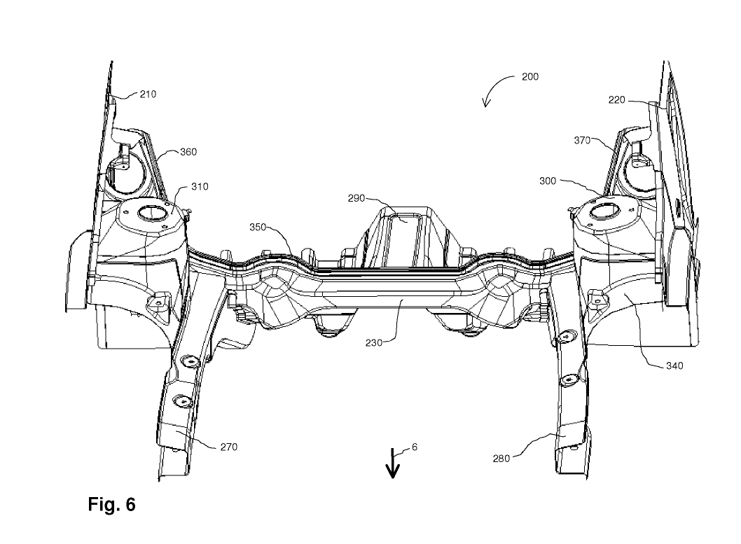

FIG. 4, FIG. 5, and FIG. 6 show a possible embodiment of a body structure 200, which is suitable for receiving a bulkhead module 100 according to FIG. 2 and FIG. 3. The body structure 200 comprises two lateral side wall structures 210, 220, which are aligned substantially in the direction of travel 6. The inner side wall structures 210, 220 are interconnected by means of a bulkhead cross member 230. The bulkhead cross member 230 is preferably disposed in a front floor structure 260 or floor panel of the body, on which the bulkhead module 100 with its lower longitudinal side then comes to abut. In this respect, the bulkhead cross member 230 of the body structure 200 supports the bulkhead module 100. The bulkhead cross member 230 preferably has two steering passages 240, 250, one steering passage being provided for left-hand drive vehicles and the other steering passage 250 being provided for right-hand drive vehicles.

The steering passages 240, 250 are preferably integrated in the bulkhead cross member 230 and the floor structure 260. During the final assembly of the vehicle body, the steering passage 240 or 250 not required in each case is closed by means of a cover, in particular a plastic cover, so that ingress of water, noise, and exhaust into the passenger compartment is obviated. Since the body is configured both for right-hand drive and for left-hand drive, it is no longer necessary to keep available different bodies for the respective type of drive configuration.

The front frame, which is formed by at least two front frame supports 270, 280, adjoins the inner side wall structures 210 and 220, extending in the direction of the engine compartment. The center tunnel 290 in the floor structure 260 is formed between the inner side wall structures 210, 220, preferably disposed centrally.

The body structure 200 further comprises a suspension strut mount 300, 310 on each side, which are each disposed between the respective front frame support 270 or 280 and the associated inner side wall structure 210, 220. The suspension strut mounts 300, 310 each have at least one, preferably a plurality of connection points 320, which are mounted for fastening the strut brace 7 of the bulkhead module 100, preferably to the connection points 11.1, 11.2 of the strut brace 7.

Adjoining the suspension strut mounts 300, 310 extending on both sides in the direction of the engine compartment is the front wheel installation of the body for receiving a respective wheel.

The bulkhead module 100 preferably has shoulder sections 330, on which the windshield support 4 of the bulkhead module 100 can be supported and fastened laterally to the body structure 200. A respective shoulder section 330 is preferably disposed on an inner side wall structure 210 or 220.

An adhesive channel is omitted in the area of the shoulder section 330 for the windshield support. The adhesive is provided thereby by means of surface application 380 in order to ensure the sealing to the windshield support 4 of the bulkhead module 100. Furthermore, the shoulder section 330 of the windshield support forms a further connection point 320 for the wiper system 120, which is used for a first structural screw connection of the bulkhead module 100 to the body structure 200.

As is apparent in particular from FIG. 5, the body structure 200 has a lateral windshield support 4′, which together with the windshield support 4 of the bulkhead module 100 forms the support for the windshield of the motor vehicle. The body structure 200 further has a connection point 3.1′ for the wiper system of the motor vehicle. The connection point 3.1′ corresponds with the connection point 3.1 of the bulkhead module 100 or the unit support 1, so that when the wiper system is mounted, a structural connection is made at the same time via the connection points 3.1 and 3.1′ between the bulkhead module 100 and the body structure 200 via the connection points 3.1 and 3.1′.

The body structure 200 is configured so that the bulkhead module 100 can be adhered to the body structure 200. To this end, the body structure 200 has a surface section 350 on the bulkhead cross member 230, which is formed by a preferably outwardly projecting edge section and serves as an adhesive surface. The inner side wall structures 210, 220 each have a surface section 360, 370, which serves as an adhesive surface for adhesive bonding to the bulkhead module 100. The surface sections 350, 360, 370 can be formed as a channel or at least in certain sections or in parts with an aligned bulkhead module 100, they can form a channel with the surface section 10 thereof, which serves as a so-called adhesive channel. By this means a liquid adhesive can be passed through, so that a previous surface application of adhesive is not required but the adhesive must merely be introduced into a provided sprue and then distributed over the channels to the areas provided.

As is apparent in particular from FIG. 5, a surface application of adhesive 380 is preferably provided on the shoulder section 330 for the windshield support 4.

By means of the bulkhead cross member 230 such a strong stiffening of the body structure is made possible that a dimensionally stable stiff body is ensured even before adhering the bulkhead module 100. The bulkhead cross member 230 also has an advantageous effect in regard to a significantly improved occupant protection in the event of a laterally offset frontal impact.

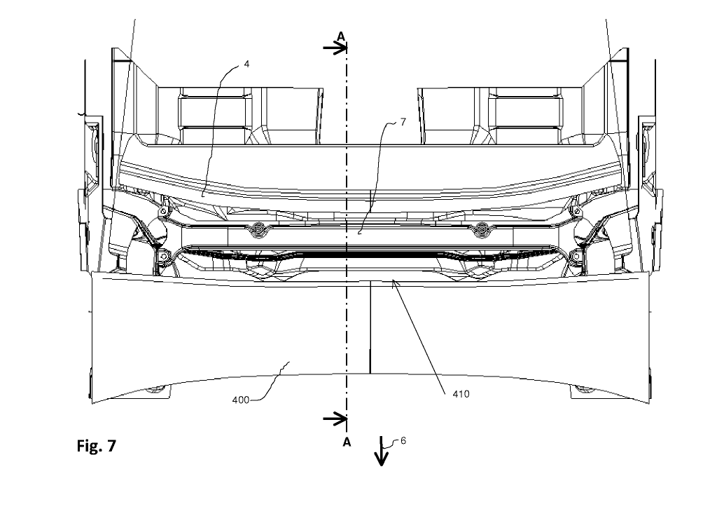

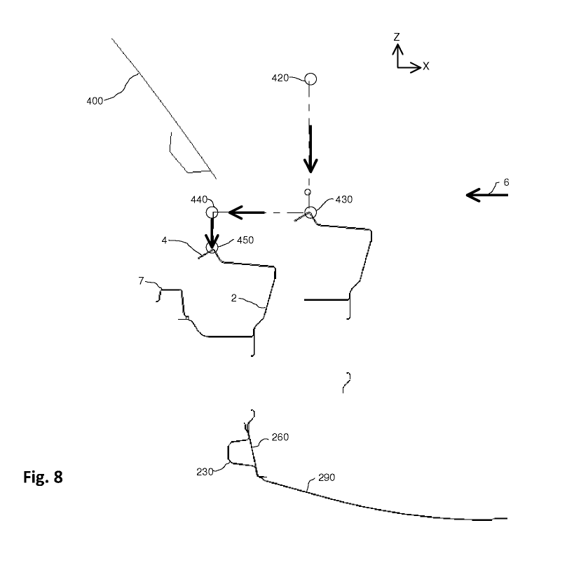

FIG. 7 and FIG. 8 show a possible procedure when installing the bulkhead module 100 according to FIG. 2 and FIG. 3 into the body structure 200 according to FIG. 4 to FIG. 6. The bulkhead module 100 is installed into the body structure 200 through the opening for the windshield formed by the two A-pillars of the body. For mounting the bulkhead module 100, the hood 400 of the motor vehicle is brought for this purpose into a predefined open position 410. The preassembled bulkhead module together with its preassembled strut brace 7 and the other already preassembled components or units in the area of the windshield opening is brought in the Z direction downward into the body of the motor vehicle from a first installation position 420 into a second installation position 430.

On reaching the previously defined Z position corresponding to the second installation position 430, the bulkhead module 100 is then brought in the X direction from the second installation position 430 into a third installation position 440 and consequently displaced in the X direction in the direction of the body structure 200 until the contour of the bulkhead module 100 is preferably positioned in a congruent manner with substantially the center of the body-side adhesive channels or adhesive surfaces 350, 360, 370, and 380. In a last assembly step the bulkhead module 100 is then lowered in the Z direction into a final installation position 450. In this final installation position, the bulkhead module 100 is substantially inserted with its surface section 10 between 10 to 20 mm, preferably 12 to 15 mm in the adhesive channels 350, 360, 370 of the body structure 200 and surrounded with adhesive.

In this final installation position 450, the units or components are fixed with respect to one another with screw connections, the bulkhead module 100 also being fixed with respect to the body structure 200 by means of appropriate screw connections. The structural screw connections fix the bulkhead module 100 on the body structure until the adhesive is completely cured so that adhesive and screw connections in combination produce a high structural stiffness of the vehicle body.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A unit support for a body of a motor vehicle, comprising:
a connection point configured for connection of a component of an engine compartment of the motor vehicle; and
a bulkhead of the motor vehicle substantially forming the unit support that separates the engine compartment from a passenger compartment, and configured for installation with the component as a preassembled structural unit into the body and configured for connection to an instrument board of the motor vehicle.

2. The unit support according to claim 1, wherein the bulkhead is formed from at least a first deep-drawn sheet joined to a second deep-drawn sheet.

3. The unit support according to claim 1, wherein the bulkhead is formed from a first extruded sheet joined to a second extruded sheet.

4. The unit support according to claim 2, wherein the first deep-drawn sheet and the second deep-drawn sheet are metal sheets.

5. The unit support according to claim 3, wherein the first extruded sheet and the second extruded sheet are metal sheets.

6. The unit support according to claim 2, wherein the first deep-drawn sheet and the second deep-drawn sheet are joined with a rivet.

7. The unit support according to claim 3, wherein the first extruded sheet and the second extruded sheet are joined with a clinch.

8. The unit support according to claim 1, further comprising at least one surface section configured to connect to a body structure.

9. The unit support according to claim 8, wherein the at least one surface section is connected to the body structure with at least one adhesive connection.

10. The unit support according to claim 8, wherein the at least one surface section is connected to the body structure with at least one screw connection.

11. The unit support according to claim 1, further comprising a plurality of connection points on the engine compartment side that serve for connection of a wiper system.

12. The unit support according to claim 1, further comprising a plurality of connection points on the engine compartment side that serve for connection of a strut brace.

13. The unit support according to claim 1, further comprising a plurality of connection points on the engine compartment side that serve for connection of a brake servo unit brace.

14. The unit support according to claim 1, further comprising a plurality of connection points on the engine compartment side that serve for connection of an insulating material.

15. The unit support according to claim 1, further comprising a plurality of connection points on the engine compartment side that serve for support of a windshield.

16. The unit support according to claim 1, further comprising a plurality of connection points on a side of the passenger compartment side configured for connection of an insulating material.

17. The unit support according to claim 1, further comprising a wiper system mounted on the unit support.

18. The unit support according to claim 1, further comprising a brake servo unit a supply tank for brake fluid mounted on the unit support.

19. The unit support according to claim 1, further comprising an insulating material mounted on the unit support.

20. The unit support according to claim 19, wherein the insulating material is a sound-insulating material.
